(19) United States
(12) Patent Application Publication
(10) Pub. No.: US 2011/0258895 A1
(43) Pub. Date: Oct. 27, 2011

(54) Automobile Message Display Device

(76) Inventor: Michael D. Rodgers, JR., Oceanside, CA (US)

(21) Appl. No.: 12/766,631

(22) Filed: Apr. 23, 2010

(51) Int. Cl. G09F 21/04; G06F 15/16

(52) U.S. Cl. 40/447; 709/206

(57) ABSTRACT

Methods and apparatus for an automobile message display device are provided. The device allows a user to compose a message on a first device, such as a cell phone, computer, or other personal electronic device and download the message to the automobile message display device. This download may be accomplished with a cable connection, or may be done wirelessly. A further embodiment allows for wireless reception of coded messages received from message transmitters. These messages are then displayed on the automobile message display device.

### BACKGROUND

1. Field

The present disclosure relates generally to message display devices, and, in particular, to an apparatus and method for displaying messages on automobiles.

2. Background

Bumper stickers have long been used to display messages on automobiles and have become increasingly popular. The bumper stickers may endorse a candidate for political office, popular brands, radio stations, and religious themes. These stickers are frequently attached to the rear bumpers of automobiles, but may also be attached anywhere on the rear of the vehicle. Some stickers are even designed to cover the rear window and are perforated to provide rear visibility to the driver.

The bumper sticker has an adhesive backing allowing it to adhere to the automobile. As long as the owner or driver wants the bumper sticker to remain in place, this adhesive is wanted. However, in some cases the owner or driver no longer wants to display the bumper sticker. This poses a problem as the adhesive may make the bumper sticker difficult to remove. In many cases, the bumper sticker tears and comes apart during the removal process, making complete removal difficult. Another possibility is that while the bumper sticker is removed, the adhesive leaves behind a discolored and sticky section on the vehicle. This residue may attract dust and dirt, and in some cases, the finish of the vehicle is damaged.

While many bumper stickers are used for novelty or entertainment purposes, others may serve a valuable public service purpose. Some bumper stickers are attached to police or other public safety vehicles and provide information on public safety services such as safe places for children, police or fire phone numbers and the like. Still other bumper stickers may serve as advertising and may be placed on cabs or buses. In these cases, the bumper stickers may still need to be changed as the services offered change.

Bumper stickers are used for a variety of messages that may change over time. There is a need in the art for an apparatus and method for an automobile message display device.

### SUMMARY

A method of displaying a message on an automobile is provided. The method includes the step of composing a message on a first device, connecting the first device to the automobile message display device. Once the connection is established the message to be displayed is downloaded to the automobile message display device. The message is stored in a memory. Once received by the automobile message display device, the message is displayed.

A further embodiment of the method provides for the display of messages that may be transmitted from message transmitters. This method includes the steps of scanning for message transmissions. These transmissions may be of a public service nature or may be emergency messages. Once received the message is displayed on the automobile message display device while the moving automobile is within range of the transmitter supplying the message.

In one embodiment the automobile message display device includes a screen for displaying the messages and a frame to retain and protect the screen. The frame provides provisions for mounting the unit. The automobile message display device incorporates an electronics package containing a processor and a memory, both of which are electrically connected to the display screen. A cable allows the automobile message display device to connect to the automobile's power supply.

In a further embodiment the automobile message display device incorporates means for wirelessly connecting the automobile message display device to a first device where a message to display is composed. Additionally, the automobile message display device includes means for downloading the message from the device where the message is composed, means for storing the message, and means for displaying the message.

In a still further embodiment, the automobile message display device includes means for scanning for a transmitted message. The transmitted message may be transmitted by a cell tower or other message transmitting device, such as that used for transmitting emergency messages. The unit also includes means for continuing to display the message while the unit is within range of the transmitter.

A still further embodiment provides a processor readable medium that provides instructions for scanning for a transmitted message. The instructions also provide for receiving the transmitted message. Further instructions provide for displaying the transmitted message while the automobile message display device is within range of a message transmitter.

Various aspects and embodiments of the invention are described in further detail below.

### BRIEF DESCRIPTION OF THE DRAWINGS

FIG. 1 is an illustration of an automobile message display device, in accordance with various embodiments of the present invention.

FIG. 2 is an illustration of the installation of an automobile message display device, in accordance with one or more embodiments the present invention.

FIG. 3 is an illustration of a mounting frame for mounting an automobile message display device on a vehicle, according to one or more embodiments of the present invention.

FIG. 4 is an illustration of the display and interconnection provisions of an automobile display device, according to one or more embodiments of the present invention.

FIG. 5 is a flowchart of the process of using an automobile message display device, according to one or more embodiments of the present invention.

FIG. 6 is a flowchart of the process of wireless message detecting and message changing using an automobile message display device, according to one or more embodiments of the present invention.

FIG. 7 is a block diagram of an automobile message display device, according to one or more embodiments of the present invention.

### DETAILED DESCRIPTION

Various embodiments are now described with reference to the drawings, wherein like reference numerals are used to refer to like elements throughout. In the following description, for purposes of explanation, numerous specific details are set forth in order to provide a thorough understanding of one or more embodiments. It may be evident, however, that such embodiment(s) may be practiced without these specific details. In other instances, well-known structures and devices are shown in block diagram form in order to facilitate describing one or more embodiments.

In the following paragraphs, the present invention will be described in detail by way of example with reference to the attached drawings. Throughout this description, the preferred embodiment and examples shown should be considered as exemplars, rather than as limitations on the present invention. As used herein, the “present invention” refers to any one of the embodiments of the invention described herein, and any equivalents. Furthermore, reference to various feature(s) of the “present invention” throughout this document does not mean that all claimed embodiments or methods must include the referenced feature(s).

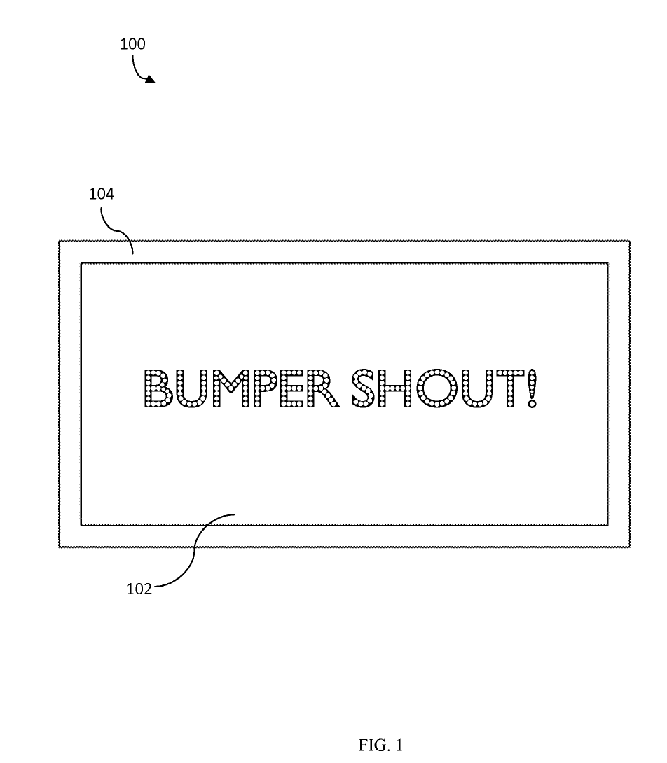

FIG. 1 illustrates the automobile message display device according to an embodiment. The automobile message display device 100 is comprised of the display 102 and related electronics, and a mounting frame 104. The automobile message display device 100 may be the size of a standard automobile license plate in one embodiment, but other sizes are contemplated. The display 102 includes a display screen that is similar to the display screens found on cell phones and other portable electronic devices. The screen of display 102 may be viewed from any angle without distortion or deterioration of the visual quality. Display 102 is surrounded and protected by mounting frame 104. Mounting frame 104 includes provisions for mounting the automobile message display device on a vehicle.

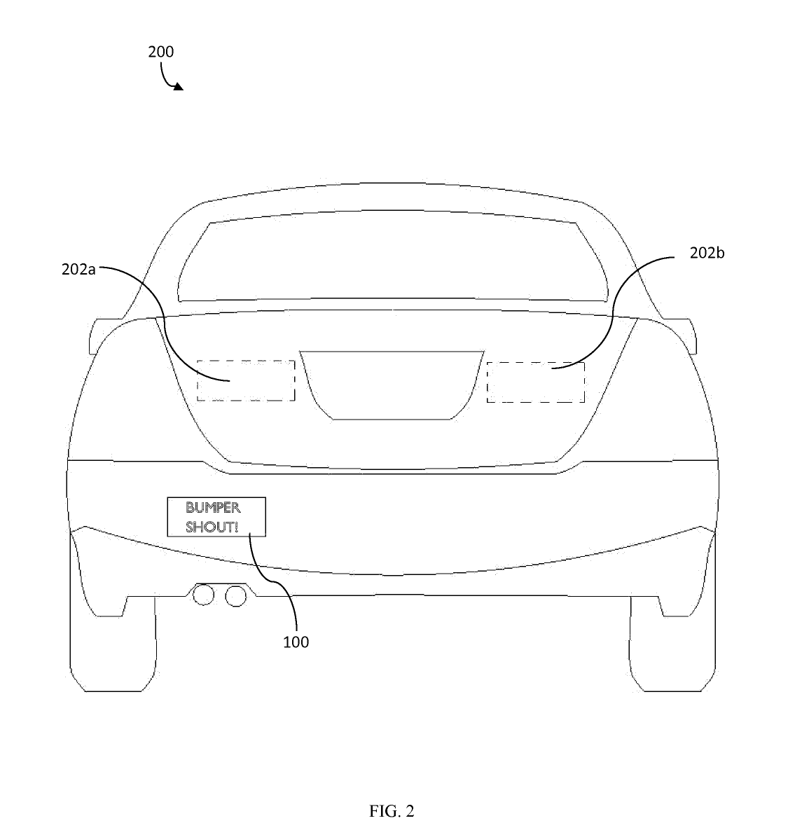

FIG. 2 depicts installation 200 of the automobile message display device on a vehicle. The automobile message display device 100 is shown installed on the left rear of the vehicle bumper, where bumper stickers are conventionally displayed. However, the automobile message display device 100 may also be installed on the rear body or trunk area of the vehicle. Positions 202a and 202b illustrate that the automobile message display device installed on the left rear of the vehicle at 202a and at the right rear of the vehicle 202b. However, these illustrations are not intended to limit the installation areas for the automobile message display device, as the automobile message display device may be installed wherever a tie-in to the vehicle electronic and power system is available.

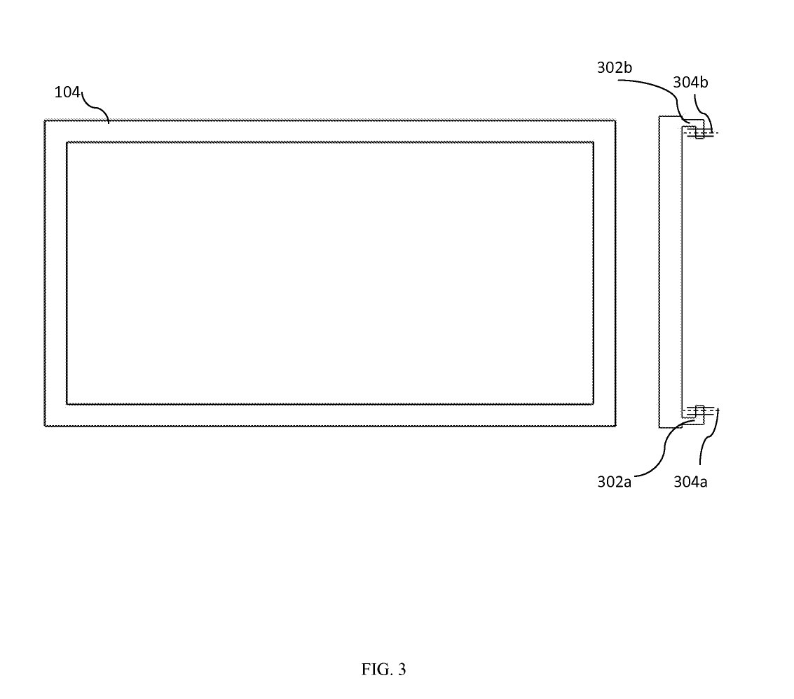

FIG. 3 shows a possible configuration of mounting frame 104. Mounting frame 104 encloses and protects the display and electronics. Mounting frame 104 may have brackets 302a and 302b to facilitate mounting using holes 304a and 304b. The vehicle frame may be modified at the rear or trunk area or bumper to accommodate the automobile message display device. This may be done using an enclosure to house the automobile message display device within the frame or body of the vehicle. This facilitates access to the vehicle power supply. This option also provides for protection against theft and could be installed during initial vehicle assembly.

While mounting frame 104 illustrates through-hole mounting of the automobile message display device, other mounting methods, including magnetic and pressure fit brackets are within the scope of the invention. The automobile message display device may be mounted using posts, screws or other attachments. For any mounting option, the automobile message display unit incorporates security measures that ensure that the unit will not operate if removed inappropriately.

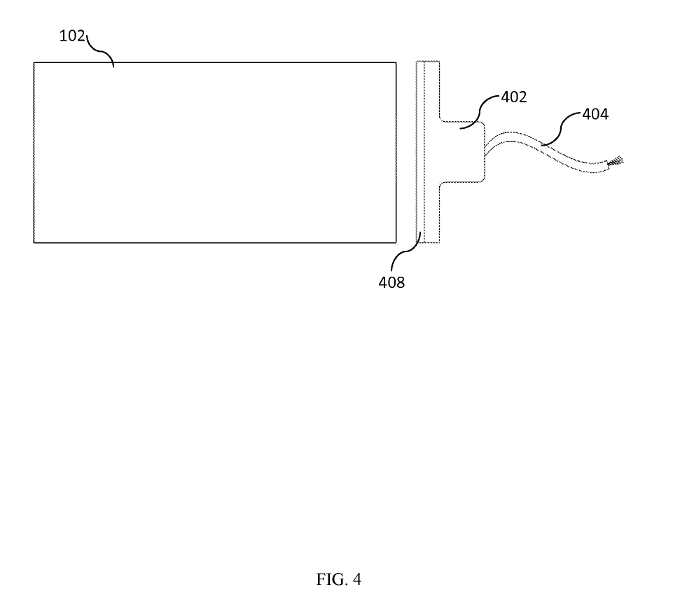

FIG. 4 illustrates the display 102 portion of the automobile message display device. The display screen is protected by protective layer 408. Protective layer 408 guards against damage from objects that may strike the display 102. This protective layer 408 may also protect the display 102 against display degradation in strong sunlight or other light source, such as vehicle headlights. Display 102 may be viewed from any angle without deterioration of the quality of the display.

Display 102 is connected to the electronics package 402. Electronics package 402 incorporates the processing capability to display the message as well as receive and direct data to the display screen. The range of data to be displayed is similar in quality, intensity, and clarity to that displayed with still images or streaming video. The information displayed may be still images, characters, streaming video, or any combination of the above. The displayed message may be comparable to messages displayed on cell phones, or other personal electronic devices.

Electronics package 402 is internally connected to cable 404. Cable 404 is designed to provide an electrical interface with the vehicle's power system. Cable 404 allows the automobile message display device to be connected to the vehicle's power electric power system. This connection to the vehicle electrical power system may be accomplished using a variety of known means, including hard wiring of the device.

The automobile message display device is capable of receiving data from a variety of input sources. An interface connection is provided on the automobile message display device allows the device to be connected to a cell phone, computer, or other electronic device, or from a remote control device specifically designed to interface with the automobile message display device.

Content for display may be downloaded to the automobile message display device from other electronic devices, which may be connected to the Internet. This download may also be accomplished using wireless transmissions. A software application may also provide a download interface to the automobile message display device.

The automobile message display device requires messages for display to be downloaded to the device. Because the device is mounted on the rear of the vehicle, it is impractical to have direct keyboard entry of data for display. For obvious safety reasons, such a display could not be used during travel.

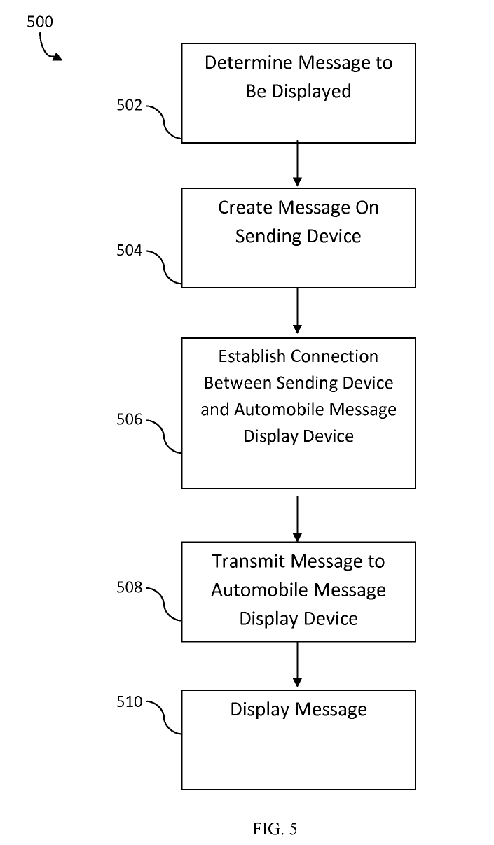

FIG. 5 provides a flowchart of the downloading of data to be displayed. The process, 500, begins when the user determines the message to be displayed, step 502. The user creates the message on the sending device in step 504. As noted above, the sending device may be a cell phone, computer, or other personal electronic device. In step 506 a connection is established between the sending device and the automobile message display device. This connection may be a physical connection using a cable interface, or may be a wireless proximity connection, such as is used on hand-free handsets for cell phones.

Once the connection is established in step 506 the message is transmitted to the automobile display device and is stored in the memory of the device in step 508. If the user has removed the automobile message display device from the vehicle to load a message for display, the unit is returned to the vehicle and re-mounted and connected to the vehicle's power supply. Once the unit is reinstalled and the vehicle is powered up, the message is displayed in step 510.

A further embodiment provides for additional sources of data for display on the automobile message display device. This embodiment provides for wireless transmission of messages to be displayed on all automobile message display devices within reach of the transmitter. This feature may prove helpful in displaying emergency messages that are for the public benefit. Examples include information such as found in “Amber” alerts issued for child kidnapping. Currently, these alerts are displayed on “smart” highway signs that are electronic billboards. While many highways have these signs, many others do not, leaving many alerts unseen by many individuals. Providing these alerts through automobile message display devices may be done wirelessly, and through existing cell towers. In such emergency cases, local law enforcement messages temporarily override the owner's displayed message.

Other types of messages could also be wirelessly downloaded for display, including advertising messages. Advertisers send advertising information to sections of the cell phone or other network near their location. This could be done while the automobile message display device is not being used by the vehicle owner, such as when the vehicle is parked. At such times, the automobile display device is in “sleep” mode. Users could opt out of the service, or advertisers could offer incentives to vehicle owners to encourage participation. A power saver feature within the automobile message display device prevents display of advertising content from draining the vehicle battery and would stop display when power dropped below critical vehicle operation levels.

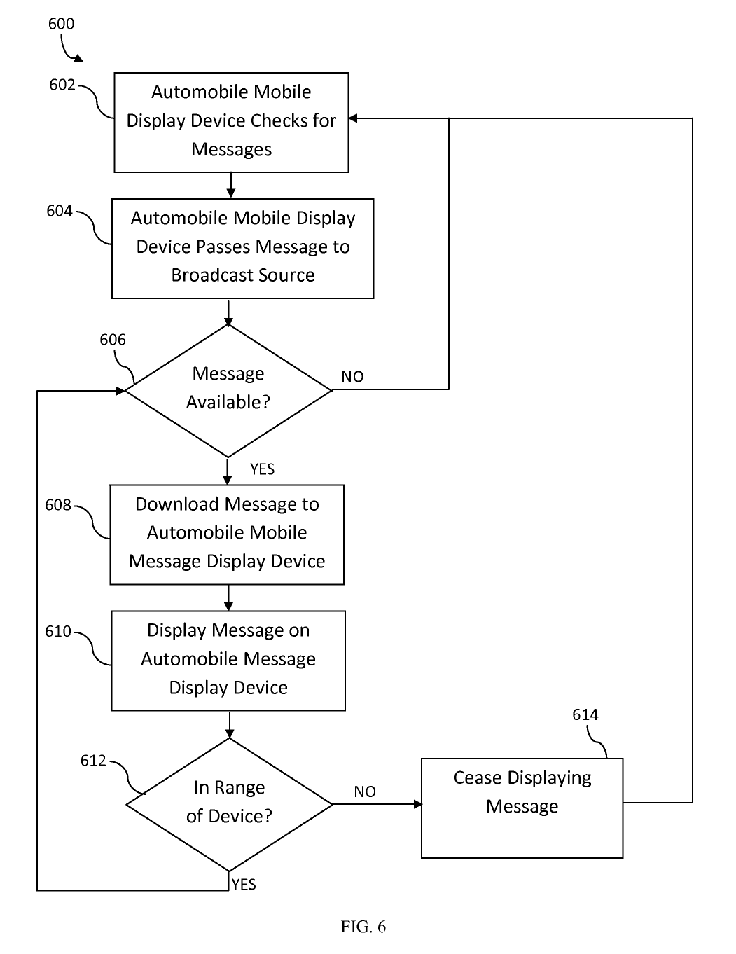

FIG. 6 provides a flowchart of automatic message display on the automobile message display device. The process 600 begins when the automobile message display device checks for messages in step 602. This may be occur while the vehicle is passing cell towers or other transmitter locations, and is documented in step 604. The automobile message display device checks to see if a message is available in step 606. If a message is not available, the unit returns to step 602 and continues to check for messages. As discussed above, these messages may be emergency messages to be displayed for public information and assistance. These messages may have special encryption or coding that may be recognized by the automobile message display device. This coding allows the emergency message to override any currently displayed message.

If a message is available, the message is automatically downloaded to the automobile message display device in step 608. The message may be downloaded to a device memory. The automobile message display device displays the message in step 610. The message continues to be displayed as long as the unit remains within the range of the transmission device. In step 612, the automobile message display device checks to determine if the unit is in range of the device. If the unit is no longer within range, the unit ceases displaying the message in step 614. If the unit remains in range, the message continues to be displayed and the process returns to step 606, where a check is once again made for a message.

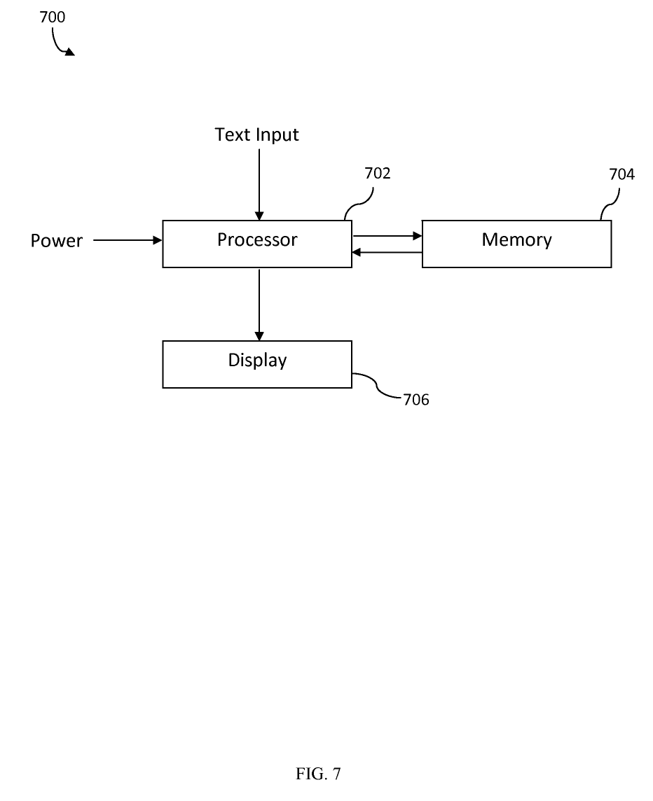

FIG. 7 is a block diagram 700 of the electronics package of the automobile message display device. The electronics package includes a processor 702. The processor is capable of receiving text inputs for display and is also connected to a power source. Processor 702 is also connected to memory 704. Memory 704 stores the message to be displayed and may also contain device instructions accessed by the processor during the download process. Processor 702 is also connected to display 706.

While various embodiments of the present invention have been described above, it should be understood that they have been presented by way of example only, and not of limitation. Likewise, the various diagrams may depict an example architectural or other configuration for the invention, which is done to aid in understanding the features and functionality that may be included in the invention. The invention is not restricted to the illustrated example architectures or configurations, but the desired features may be implemented using a variety of alternative architectures and configurations. Indeed, it will be apparent to one of skill in the art how alternative functional, logical or physical partitioning and configurations may be implemented to implement the desired features of the present invention. Also, a multitude of different constituent module names other than those depicted herein may be applied to the various partitions. Additionally, with regard to flow diagrams, operational descriptions and method claims, the order in which the steps are presented herein shall not mandate that various embodiments be implemented to perform the recited functionality in the same order unless the context dictates otherwise.

Although the invention is described above in terms of various exemplary embodiments and implementations, it should be understood that the various features, aspects and functionality described in one or more of the individual embodiments are not limited in their applicability to the particular embodiment with which they are described, but instead may be applied, alone or in various combinations, to one or more of the other embodiments of the invention, whether or not such embodiments are described and whether or not such features are presented as being a part of a described embodiment. Thus the breadth and scope of the present invention should not be limited by any of the above-described exemplary embodiments.

Terms and phrases used in this document, and variations thereof, unless otherwise expressly stated, should be construed as open ended as opposed to limiting. As examples of the foregoing: the term “including” should be read as meaning “including, without limitation” or the like; the term “example” is used to provide exemplary instances of the item in discussion, not an exhaustive or limiting list thereof; the terms “a” or “an” should be read as meaning “at least one,” “one or more” or the like; and adjectives such as “conventional,” “traditional,” “normal,” “standard,” “known” and terms of similar meaning should not be construed as limiting the item described to a given time period or to an item available as of a given time, but instead should be read to encompass conventional, traditional, normal, or standard technologies that may be available or known now or at any time in the future. Likewise, where this document refers to technologies that would be apparent or known to one of ordinary skill in the art, such technologies encompass those apparent or known to the skilled artisan now or at any time in the future.

A group of items linked with the conjunction “and” should not be read as requiring that each and every one of those items be present in the grouping, but rather should be read as “and/or” unless expressly stated otherwise. Similarly, a group of items linked with the conjunction “or” should not be read as requiring mutual exclusivity among that group, but rather should also be read as “and/or” unless expressly stated otherwise. Furthermore, although items, elements or components of the invention may be described or claimed in the singular, the plural is contemplated to be within the scope thereof unless limitation to the singular is explicitly stated.

The presence of broadening words and phrases such as “one or more,” “at least,” “but not limited to” or other like phrases in some instances shall not be read to mean that the narrower case is intended or required in instances where such broadening phrases may be absent. The use of the term “module” does not imply that the components or functionality described or claimed as part of the module are all configured in a common package. Indeed, any or all of the various components of a module, whether control logic or other components, may be combined in a single package or separately maintained and may further be distributed across multiple locations.

Additionally, the various embodiments set forth herein are described in terms of exemplary block diagrams, flow charts and other illustrations. As will become apparent to one of ordinary skill in the art after reading this document, the illustrated embodiments and their various alternatives may be implemented without confinement to the illustrated examples. For example, block diagrams and their accompanying description should not be construed as mandating a particular architecture or configuration.

The previous description of the disclosed embodiments is provided to enable any person skilled in the art to make or use the present invention. Various modifications to these embodiments will be readily apparent to those skilled in the art, and the generic principles defined herein may be applied to other embodiments without departing from the spirit or scope of the invention. Thus, the present invention is not intended to be limited to the embodiments shown herein but is to be accorded the widest scope consistent with the principles and novel features disclosed herein.

1. A method of displaying a message, comprising:
composing a message on a first device;
connecting the first device to a display device;
downloading the message to the display device;
storing the message in the display device, and
displaying the message on the display device.

2. A method of displaying a message, comprising:
scanning for a transmitted message to display on an automobile message display device;
receiving the transmitted message on the automobile message display device; and
displaying the transmitted message on the automobile message display device while the automobile message display device is within range of a message transmitter.

3. The method of claim 2, where the transmitted message is an emergency message.

4. The method of claim 2, where the transmitted message is an advertising message.

5. The method of claim 4, where the automobile message display device is in a sleep state when the advertising message is received, and wherein the automobile message display device activates and displays the advertising message.

6. An apparatus for displaying a message, comprising:
a screen,
a frame to retain and protect the screen, incorporating mounting provisions,
an electronics package comprising a processor and a memory, the processor and the memory in electronic communication with the screen.

7. The apparatus of claim 6, further comprising a receiving device within the electronics package for receiving transmitted display messages from external sources.

8. An automobile message display device, comprising:
means for scanning for a transmitted message to display on an automobile message display device;
means for receiving the transmitted message on the automobile message display device, and;
means for displaying the transmitted message on the automobile message display device while the automobile message display device is within range of a message transmitter.

9. A processor readable medium including instructions thereon that may be utilized by one or more processors, the instructions comprising:
instructions for downloading a message from a composing device to an automobile message display device;
instructions for storing the message on the automobile message display device, and
instructions for displaying the message on the automobile message display device.

10. A processor readable medium including instructions thereon that may be utilized by one or more processors, the instructions comprising:
instructions for scanning for a transmitted message to display on an automobile message display device;
instructions for receiving the transmitted message on the automobile message display device; and
instructions for displaying the transmitted message on the automobile message display device while the automobile message display device is within range of a message transmitter.
